(19) United States
(12) Patent Application Publication
(10) Pub. No.: US 2024/0206378 A1
(43) Pub. Date: Jun. 27, 2024

(54) MOBILE SYSTEM FOR HARVESTING AND/OR TRANSPORTING AND/OR LOADING SUGAR BEETS, SUGAR PRODUCTION SYSTEM AND METHOD FOR SUGAR PRODUCTION

(71) Applicant: PFEIFER & LANGEN IP GMBH & CO. KG, KöIn (DE)

(72) Inventors: Mark-Oliver BURKHARDT, Pfungstadt (DE); Wolfgang KLOSTERHALFEN, Kerpen (DE)

(21) Appl. No.: 18/287,564

(22) PCT Filed: Apr. 21, 2022
(86) PCT No.: PCT/EP2022/060615

§ 371 Date: Oct. 19, 2023

(30) Foreign Application Priority Data
Apr. 23, 2021 (EP) 21170222.0

(51) Int. Cl. A01D 33/08; C13B 5/06; C13B 10/08; G01N 21/3563; G01N 21/359; G01N 21/84

(52) U.S. Cl. CPC A01D 33/08; C13B 5/06; C13B 10/083; G01N 21/3563; G01N 21/359; G01N 2021/8466

(57) ABSTRACT

The present invention relates to a mobile system for harvesting and/or transporting and/or loading sugar beets, comprising an optical imaging system (70) configured to determine at least a useful portion of the sugar beets suitable for sugar production and/or to determine at least a residual portion of the sugar beets not suitable for sugar production. The invention further relates to a sugar production system with such a mobile device (51, 52, 53) and with a sugar production system which is set up to set at least one process parameter depending on the useful portion and/or residual portion determined with the optical image capture system (70). The invention further relates to a method for sugar production, wherein sugar beets are harvested and/or transported and/or loaded using a mobile system (51, 52, 53), wherein with an optical image capture system (70) of the mobile system (51, 52, 53) at least one useful portion that is suitable for sugar production and/or at least one residual portion of the sugar beet that is not suitable for sugar production is determined, wherein at least one process parameter is set in a sugar production plant depending on the useful portion and/or the residual portion determined with the optical image capture system.

### PRIOR ART

The present invention relates to a mobile system for harvesting and/or transporting and/or loading sugar beets. Another subject of the invention is a sugar production system. The invention further relates to a method for sugar production.

For industrial sugar production based on sugar beets, it is essential to record quality-related parameters of the sugar beets shortly after they are harvested in order to adapt production processes such as sugar extraction or juice purification to the quality of the sugar beets. Such sugar beet parameters are usually recorded by trained personnel who inspect the sugar beet. In addition, samples are usually taken and examined in a laboratory, for example to determine the sugar content. The sampling and subsequent examination in the laboratory is associated with a certain processing time, which must be waited before the results of the analysis are available and reactions, such as setting process parameters, are possible.

DE 10 2018 127 846 A1 describes a method in which an optical image capture unit is used to record a test image which shows root crops that are recorded on a sieve belt or a roller cutter. The method evaluates the composition of the crop stream. The evaluation shows the respective portions of root crops and admixtures in the form of herbs, soil and stones. The relationships between the products and additives present in the crop flow are recorded separately and compared with target values. This results in control variables for individual operating parameters, such as the driving speed, the harvesting depth and/or the separating devices that separate the beets from the admixtures.

GB 2 377 019 A discloses a method for separating beets and admixtures in the form of stones and chunks of earth by vibration.

### DISCLOSURE OF THE INVENTION

Against this background, it is the object of the present invention to enable the quality of sugar beets to be determined after their harvest with little time and personnel effort.

To achieve the object, a mobile system for harvesting and/or transporting and/or loading sugar beets is proposed, which has an optical image capture system that is used to determine at least one useful portion of the sugar beet that is suitable for sugar production and/or to determine at least one residual portion of the sugar beet that is not suitable for sugar production.

The mobile system according to the invention includes an optical image capture system through which quality-related parameters of the sugar beets can be determined shortly after they have been harvested. It is therefore possible to adapt the processes occurring in sugar production, for example in juice extraction and/or juice purification, to the determined quality of the sugar beet. It is not necessary to employ trained personnel to inspect the sugar beets. In addition, the results of the determination—i.e., one or more useful portions of the sugar beet that are suitable for sugar production and/or those of one or more residual portions of the sugar beet that are not suitable for sugar production—are available with a short time delay.

The optical image capture system is preferably set up to determine several useful portions of the sugar beet that are suitable for sugar production, for example a portion of beet heads and/or beet bodies and/or beet tails. Alternatively or additionally, it can be provided that the optical image capture system is set up to determine several residual portions of the sugar beet that are not suitable for sugar production, for example a portion of leaves, weeds and/or dirt. For this purpose, the optical image capture system can include an image recognition unit, which can be designed as a hardware and/or software unit.

According to an advantageous embodiment of the invention, the mobile system comprises a beet holder for receiving at least a first subset of the sugar beets as a bed or beet stream, wherein the optical image capture system comprises a first optical image capture device for detecting the bed, which is configured to determine a portion of beet heads and/or beet bodies and/or beet tails in the bed or the beet stream as the useful portion and/or to determine a portion of foreign bodies, in particular leaves, weeds or dirt, in the bed or the beet stream as a residual portion. Such a design enables contactless detection of uncrushed sugar beets. The first optical image capture device can be designed as a camera. By determining the portion of beet heads and/or beet bodies and/or beet tails, statements can be made about the quality of the sugar beet. By determining the portion of leaves, weeds or dirt, a statement can be made about the quality of the harvest. Optionally, depending on the determined portion of foreign bodies, in particular leaves, weeds and dirt, this portion can also be separated from the sugar beets or this portion can be removed. In this respect, a separating device is preferably provided for separating the specific residual portion, in particular the portion of foreign bodies, from the bed or the beet stream. The removal can be selected according to the type of foreign bodies, for example using compressed air, flaps or grippers.

According to an advantageous embodiment of the invention, the mobile system comprises a cutting device for cutting at least a second subset of the sugar beets into a cut subset comprising cut sugar beets and foreign bodies, in particular leaves, weeds or dirt, and a near-infrared spectroscopy device for determining ingredients of the cut subset, in particular the cut sugar beets, wherein the optical image capture system has a second optical image capture device for detecting the cut subset, which is configured to determine a portion of the cut sugar beets as the useful portion and/or a portion of the foreign bodies in the cut subset as the residual portion. The combination of optical image capture with the near-infrared spectroscopy device makes it possible to obtain information about individual ingredients in the beets and their content. Optionally, the combination can also provide information about the degree of rotting of the sugar beets, for example by means of color recognition. The near-infrared spectroscopy device—also known as a NIRS device—can record measurement data from which conclusions can be drawn about the ingredients of the cut sugar beets examined. The NIRS device uses a method in which the cut sugar beets to be examined are irradiated with electromagnetic radiation in the near infrared range, for example in a spectral range from 400 nm to 2,500 nm. Such irradiation can stimulate molecular vibrations in the material being examined. The electromagnetic radiation triggered by the molecular vibrations in the near-infrared range, for example in a spectral range from 400 nm to 2,500 nm, is detected and resolved spectroscopically. The type and/or amount of ingredients in the materials examined can be determined from the recorded spectra. The cut sugar beets can be detected with the near-infrared spectroscopy device without further treatment. The near-infrared spectroscopy device can preferably comprise a plurality of detectors which are arranged in different orientations relative to the cut sugar beets. Through such contactless measurement from multiple directions, the ingredients can be determined with increased accuracy. The second optical image capture device can be designed as a camera. Preferably, the second optical image capture device is configured to determine one or more geometric properties of the cut sugar beets, in particular a length and/or a width and/or a cross-sectional area. The additionally determined optically detectable properties of the cut sugar beets can improve the analysis. The optical image capture device is preferably directed at the same area of the cut subset as the near-infrared spectroscopy device, so that the first measurement data of the near-infrared spectroscopy device and the properties determined by the optical image capture device relate to identical cut sugar beets. Optionally, depending on the determined portion of foreign bodies, in particular leaves, weeds and dirt, this portion can also be separated from the sugar beets or this portion can be removed. In this respect, a separating device is preferably provided for separating the specific residual portion, in particular the portion of foreign bodies, from the cut subset. The removal can be selected according to the type of foreign bodies, for example using compressed air, flaps or grippers.

The cutting device is preferably set up to cut the sugar beet along an axis of the sugar beet, for example into two halves, three thirds or four quarters. In this respect, the cut sugar beets can be designed as sugar beet halves, sugar beet thirds or sugar beet quarters. Alternatively, it can be provided that the cutting device is set up to shred the sugar beets into sugar beet pulp, so that the cut sugar beets are designed as sugar beet pulp.

An advantageous embodiment of the invention provides that the mobile system is designed as a beet harvester and has a harvesting device for harvesting the sugar beets and a storage bunker for storing the sugar beets. The storage bunker can form the beet holder for receiving the first portion of the sugar beets as a bed. Such a design of the mobile system offers the advantage that the sugar beets can be analyzed in the field immediately after they have been harvested.

The beet harvester preferably includes a position determination device through which the position of the beet harvester in the respective agricultural field can be determined. This makes it possible to link the useful portion and/or residual portion determined with the optical image capture device to the position and to make statements about the distribution of the quality of the sugar beets within the field. The beet harvester preferably comprises a feed device which is set up to feed sugar beets from the storage bunker to the cutting device. Sugar beets can be removed from the storage bunker via the feed device and fed to analysis by crushing and subsequent detection by the near-infrared spectroscopy device and the second optical image capture device. Alternatively, it can be provided that the mobile system, in particular the beet harvester, comprises a feed device which is set up to feed beets harvested with the harvesting device to the cutting device without the sugar beets getting into the storage bunker.

An alternative, advantageous embodiment of the invention provides that the mobile system is designed as a beet cleaning loader and has a receiving unit for receiving sugar beets, a cleaning unit for cleaning the picked up sugar beets and an overloader for dispensing the cleaned sugar beets, in particular to a separate transport vehicle. Such beet cleaning loaders are also referred to as MAUS, where the abbreviation is made up of the first letters of the words Mieten, Aufnahme, Umladen und System (windrow, pick-up, reload and system). The beet cleaning loader can pick up sugar beets from a windrow in the field, clean them and load them into a suitable transport vehicle. The beet cleaning loader preferably comprises a feed device which is set up to feed cleaned beets to the cutting device. Alternatively, it can be provided that the beet cleaning loader comprises a feed device which is set up to feed beets from the overloader to the cutting device.

An alternative, advantageous embodiment of the invention provides that the mobile system is designed as a beet transporter and has a loading area for receiving the sugar beets. Such an embodiment offers the advantage that the analysis of the sugar beets can be carried out during transport, for example to a sugar production plant. The further processing steps after transport can then be quickly coordinated with the results of the analysis. The beet transporter preferably has a feed device which is set up to feed sugar beets from the loading area to the cutting device.

The mobile system preferably comprises a communication interface, in particular for wireless communication, via which data regarding the specific useful portion and/or a specific residual portion and/or the specific ingredients can be transmitted, in particular to a sugar production plant.

To achieve the object mentioned at the beginning, a sugar production system is also proposed, with a mobile device explained above and with a sugar production plant, wherein the sugar production plant is set up to set at least one process parameter depending on the useful portion and/or residual portion determined with the optical image capture system.

The sugar production system can achieve the same advantages as those described in connection with the mobile system.

According to an advantageous embodiment of the sugar production system, it is provided that the sugar production plant is set up to additionally set the process parameter depending on the ingredients determined using the near-infrared spectroscopy device.

Another subject of the invention is a method for sugar production,
wherein sugar beets are harvested and/or transported and/or loaded using a mobile system,
wherein an optical image capture system of the mobile system is used to determine at least one useful portion of the sugar beet that is suitable for sugar production and/or at least one residual portion of the sugar beet that is not suitable for sugar production,
wherein in a sugar production plant at least one process parameter is set depending on the useful portion determined with the optical image capture system and/or the residual portion.

The method for sugar production can achieve the same advantages as those described in connection with the mobile system.

An advantageous embodiment of the method provides that a first subset of the sugar beets is recorded as a bed in a beet holder of the mobile system, wherein the optical image capture system has a first optical image capture device for detecting the bed, with which a portion of beet heads and/or beet bodies and/or beet tails in the bed is determined as the useful portion and/or with which a portion of foreign bodies, especially leaves, weeds or dirt, is determined as the residual portion. With such a design of the method, sugar beets are detected without contact, without it being necessary to shred them up. By determining the portion of beet heads and/or beet bodies and/or beet tails, statements can be made about the quality of the sugar beet. By determining the portion of leaves, weeds or dirt, a statement can be made about the quality of the harvest. Optionally, depending on the determined portion of foreign bodies, in particular leaves, weeds and dirt, this portion can also be separated from the bed or the beet stream or this portion can be removed. The removal can be selected according to the type of foreign bodies, for example using compressed air, flaps or grippers.

An advantageous embodiment of the method provides that at least a second subset of the sugar beets is shredded with a cutting device of the mobile system into a cut subset comprising cut sugar beets and foreign bodies, wherein with a near-infrared spectroscopy device of the mobile system ingredients of the cut subset, in particular the cut sugar beets, are determined and wherein the optical image capture system has a second optical image capture device, with which a portion of the cut sugar beets is determined as the useful portion and/or with which a portion of the foreign bodies in the cut subset is determined as the residual portion. The combination of optical image capture with the near-infrared spectroscopy device makes it possible to obtain information about individual ingredients in the beets and their content. Optionally, depending on the determined portion of foreign bodies, in particular leaves, weeds and dirt, this portion can also be separated from the sugar beets or this portion can be removed. The removal can be selected according to the type of foreign bodies, for example using compressed air, flaps or grippers.

With the near-infrared spectroscopy device, for example, the following ingredients or their content can be specified: sucrose, fructose, glucose, lactic acid, oxalic acid, oxalates, nitrates, nitrites, pectins, dextrans, nitrogen. The optical image capture device can additionally determine the color of the material being examined, for example in the Lab color space.

An advantageous embodiment of the method provides that the sugar content, in particular sucrose, in the cut subset is determined using the near-infrared spectroscopy device of the mobile system. The sugar content is of particular importance for the further processing of the sugar beets. This means that further processing of the sugar beets that were examined with the mobile system can take place depending on the sugar content determined. For example, several batches of sugar beets can be examined with one or more mobile systems and sugar beets with similar sugar content can be combined and/or intended for further processing together. In addition, the sugar content can be used as an input variable for calculating a purchase price for the sugar beets.

An advantageous embodiment of the invention provides that the process parameter set depending on the specific useful portion and/or residual portion is a process parameter of an extraction device (diffusion) to which sugar beet pulp is fed and from which sugar beet pulp residues and raw juice are withdrawn. The process parameter can be, for example, an extraction time, which indicates the duration for which the sugar beet pulp remains in the extraction device and/or an extraction temperature, which indicates the temperature at which the extraction device is operated.

An advantageous embodiment of the invention provides that the process parameter is a process parameter of a liming step or a carbonization step or a filtration step or a thickening step (concentration) or a crystallization step or a separation step. The at least one process parameter can be, for example, an amount of lime milk added and/or a target value of the pH value and/or a concentration of the lime milk and/or an added amount of precipitated calcium carbonate (PCC for short) and/or an amount of mud juice (concentrate) withdrawn. In the thickening step and/or crystallization step, for example, an evaporation temperature (process temperature) when thickening the thin juice and/or a residence time when thickening the thin juice and/or a number of crystallization steps of the thick juice formed during thickening can be set as process parameters.

In the sugar production system and the method, the advantageous designs and features described in connection with the mobile system can also be used alone or in combination.

Further advantages, features, and details of the invention will be apparent from the drawings, and from the following description of a preferred embodiment with reference to the drawings. The drawings merely illustrate an exemplary embodiment of the invention, which does not limit the inventive concept.

### BRIEF DESCRIPTION OF THE DRAWINGS

FIG. 1 shows a method for sugar production according to an exemplary embodiment of the invention.

FIG. 2 shows a mobile system according to a first exemplary embodiment of the invention in a block diagram.

FIG. 3 shows a mobile system according to a second exemplary embodiment of the invention in a block diagram.

FIG. 4 shows a mobile system according to a third exemplary embodiment of the invention in a block diagram.

### EMBODIMENTS OF THE INVENTION

In the various figures, the same parts are always provided with the same reference numerals and are therefore usually only named or mentioned once.

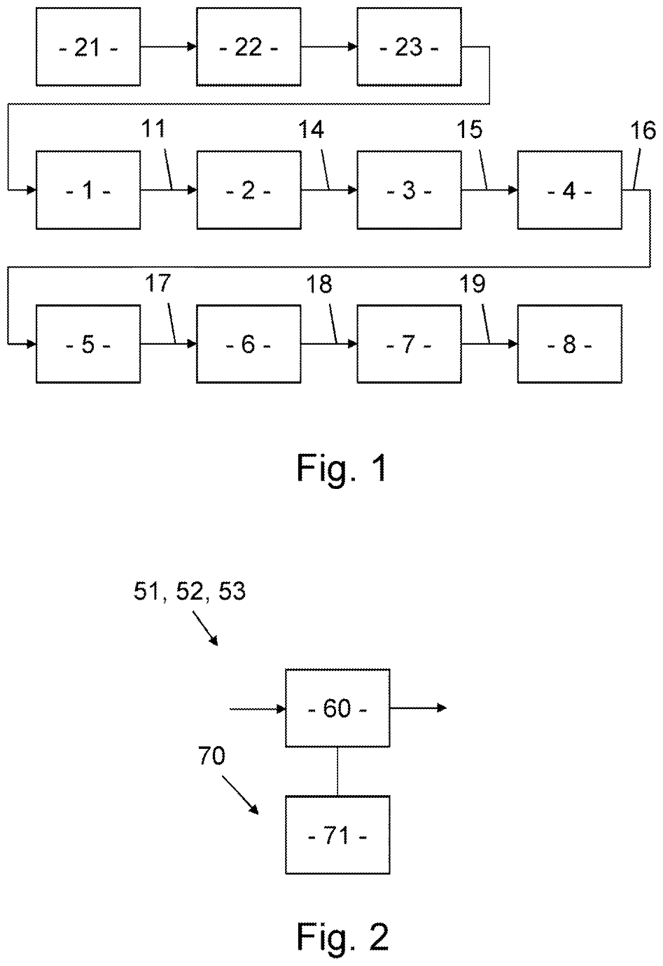

The flow chart shown in FIG. 1 shows an exemplary embodiment of a method according to the invention for sugar production. In a method step of harvesting 21, the sugar beets are first harvested with a first mobile system designed as a beet harvester and placed in windrows on the field. In a subsequent method step of loading 22, a second mobile system designed as a beet cleaning loader picks up the sugar beets, cleans them and loads the sugar beets into a third mobile system designed as a beet transporter. In a method step of transporting 23, the sugar beets are transported with the beet transporter to a sugar production plant, in which the method steps explained below are carried out.

The sugar beets delivered to the sugar production plant are preferably first cleaned again, i.e., to remove any deposits such as soil, sand or leaves. In a first method step of cutting 1, the sugar beets are shredded by a cutting machine in order to obtain sugar beet pulp 11.

In a method step of extraction 2 or juice extraction following cutting 1, the sugar beet pulp is leached into water in an extraction device. Optionally, the sugar beet pulp can first be preheated, for example in a range of 60° C. to 80° C., in order to make the cell walls more permeable. The actual extraction 2 takes place in a countercurrent method in which the sugar beet pulp is conveyed or passed through the extraction device in countercurrent to hot water. The product of extraction 2, in addition to sugar beet pulp residue, is raw juice 14, which contains almost all of the sugar contained in the sugar beet.

Lime in the form of lime milk is added to the raw juice 14 in a method step of liming 3. The lime binds non-sugar substances contained in the raw juice 14. Acids are neutralized and the pH value is raised.

In the subsequent method step of carbonization 4, carbon dioxide is introduced into the mixture 15 of raw juice and lime milk. Calcium and other non-sugar substances are bound and precipitate as lime (calcium carbonate). A mixture 15 of raw juice and precipitated non-sugar substances is obtained. In the subsequent method step of filtration 5, the lime and the non-sugar substances are then separated off and the thin juice 17 remains. The method steps of liming 3, carbonization 4 and filtration 5 are also referred to as juice purification. The steps of liming 3, carbonization 4 and filtration 5 can optionally be carried out in this order several times, for example twice, in succession to improve the cleaning result.

This is followed by the method step of thickening 6, in which the thin juice 17 is thickened in a usually multi-stage heating process in order to obtain the thick juice 18.

The thick juice is crystallized out of sugar in a method step of crystallization 7 at high temperature and negative pressure. The crystallization 7 preferably comprises several successive crystallization steps. A mixture 19 of thick juice and granulated sugar is obtained, which is also known as magma.

Finally, the crystal sugar is separated in a method step of separating 8, for example in a centrifuge.

Mobile systems 51, 52, 53 can be used in the method for sugar production, as will be explained below using the illustrations in the following figures. These mobile systems 51, 52, 53 each include an optical image capture system 70, which is configured to determine at least one useful portion of the sugar beet that is suitable for sugar production and/or to determine at least one residual portion of the sugar beet that is not suitable for sugar production.

The illustration in FIG. 2 shows a block diagram of a first exemplary embodiment of a mobile system 51, 52, 53 according to the invention. The mobile system 51, 53 can be designed as a beet harvester or as a beet transporter which has a beet holder 60 in which at least a first subset of the sugar beets is picked up as a bed. Alternatively, the mobile system 52 can be designed as a beet cleaning loader, which includes a beet holder 60 designed as a conveyor, in which a stream of beets is received.

The mobile system 51, 52, 53 also includes an optical image capture system 70 with an optical image capture device 71 for detecting the bed or the beet flow in the beet holder 60. The optical image capture device 71 is configured to record a portion of beet heads and/or beet bodies and/or beet tails as the useful portion on the bed or the beet stream and/or to determine a portion of foreign bodies, in particular leaves, weeds or dirt, in the bed or the beet stream as a residual portion. The certain useful portion or residual portion can be transferred to the sugar production plant. In the sugar production plant, the cleaning of the sugar beets can be adjusted depending on the certain residual portion.

If the mobile system 51 is designed as a beet harvester, it preferably comprises a harvesting device for harvesting the sugar beets and a beet holder 60 in the form of a storage bunker for storing the sugar beets. If the mobile system 52 is designed as a beet cleaning loader, the beet holder 60 is preferably designed as a conveyor device. The beet cleaning loader includes a receiving unit for receiving sugar beets, a cleaning unit for cleaning the picked-up sugar beets and an overloader for dispensing the cleaned sugar beets, in particular to a separate transport vehicle. The beet holder 60, designed as a conveyor device, can be arranged either in the receiving unit, the cleaning unit or the overloader. If the mobile system 53 is designed as a beet transporter, it comprises a beet holder 60 designed as a loading area.

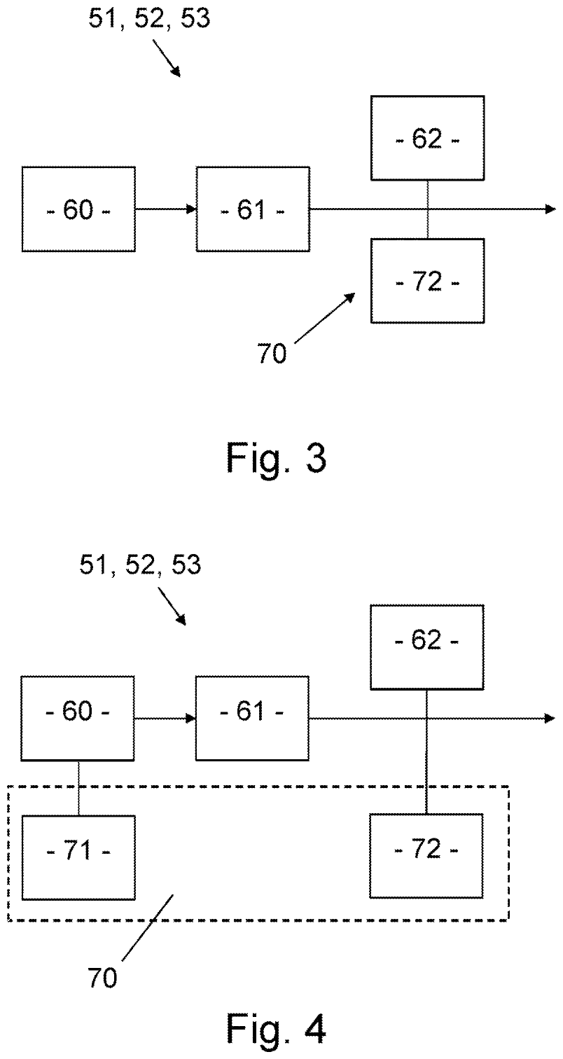

FIG. 3 shows a block diagram of a mobile system 51, 52, 53 according to a second exemplary embodiment, which has a cutting device 61 for cutting at least a second subset of the sugar beets into a cut subset. The sugar beets are fed to the cutting device 61 from a beet holder 60, which can be designed, for example, as a storage bunker for receiving a bed of sugar beets or as a conveyor device for receiving a stream of beets. The cut subset produced by the cutting device 61 includes cut sugar beets and foreign bodies, in particular leaves, weeds or dirt. The cut subset is passed—as a stream of cut sugar beets—past a near-infrared spectroscopy device 62 and an optical image capture device 72. The near-infrared spectroscopy device 62 and the optical image capture device 72 are directed at the same area of the cut subset, so that identical cut sugar beets are captured by the near-infrared spectroscopy device 62 and the optical image capture device 72. The near-infrared spectroscopy device 62 is set up to determine ingredients of the cut subset, in particular ingredients of the cut sugar beets. The optical image capture device 72 is configured to determine a portion of the cut sugar beets as the useful portion and/or a portion of the foreign bodies in the cut subset as the residual portion. The sugar content is preferably determined by the near-infrared spectroscopy device 62 and the portion of cut sugar beets is determined as the useful portion by the optical image capture device 72. This data can be transmitted to the sugar production plant, where the weight of the beet quantity delivered is determined. The amount of sugar delivered is then determined depending on the weight of the beets delivered, the specific sugar content and the specific useful portion. This value can be used to bill the quantity delivered and/or to stop sugar production. Alternatively or additionally, the specific sugar content can be used to determine the order in which certain batches of sugar beet are processed in the sugar production plant. For example, it is possible to prioritize processing damaged and/or rotten sugar beets in the sugar production plant. It is also possible to process sugar beet batches with similar sugar content together in the sugar production plant.

If the mobile system 51 is designed as a beet harvester, it preferably comprises a harvesting device for harvesting the sugar beets and a beet holder 60 in the form of a storage bunker for storing the sugar beets. Preferably, the beet harvester comprises a feed device which is set up to feed sugar beets from the storage bunker to the cutting device 61. If the mobile system 52 is designed as a beet cleaning loader, the beet holder 60 is preferably designed as a conveyor device. The beet cleaning loader includes a receiving unit for receiving sugar beets, a cleaning unit for cleaning the picked-up sugar beets and an overloader for dispensing the cleaned sugar beets, in particular to a separate transport vehicle. The beet holder 60, designed as a conveyor device, can be arranged either in the receiving unit, the cleaning unit or the overloader. Beets are fed to the cutting device 61 via a feed device. If the mobile system 53 is designed as a beet transporter, it has a beet holder 60 designed as a loading area. The beet transporter preferably has a feed device which is set up to feed sugar beets from the loading area to the cutting device 61.

FIG. 4 shows a mobile system 51, 52, 53 according to a third exemplary embodiment. The mobile system 51, 52, 53 according to the third exemplary embodiment has the same features as the mobile system 51, 52, 53 according to the second exemplary embodiment, which is why reference is made to the description of the second exemplary embodiment. In addition, the mobile system 51, 52, 53 according to the third embodiment comprises a further optical image capture device 71 for detecting the bed or the beet flow in the beet holder 60. The further optical image capture device 71 is configured to determine a portion of beet heads and/or beet bodies and/or beet tails as the useful portion on the bed or the beet stream and/or to determine a portion of foreign bodies, in particular leaves, weeds or dirt, in the bed or the beet stream as a residual portion.

### LIST OF REFERENCE NUMERALS

1 Method step “Cutting”
2 Method step “Extraction”
3 Method step “Liming”
4 Method step “Carbonisation”
5 Method step “Filtration”
6 Method step “Thickening”
7 Method step “Crystallisation”
8 Method step “Separating”
11 Sugar beet pulp
14 Raw juice
15 Mixture of raw juice and lime milk
16 Mixture of raw juice and precipitated non-sugar substances
17 Thin juice
18 Thick juice
19 Mixture of thick juice and granulated sugar
21 Method step “Harvesting”
22 Method step “Loading”
23 Method step “Transporting”
51 Beet harvester
52 Beet cleaning loader
53 Beet transporter
60 Beet holder
61 Cutting device
62 Near-infrared spectroscopy device
70 Image capture system
71 Image capture device
72 Image capture device

1. A mobile system for harvesting and/or transporting and/or loading sugar beets, characterized by
an optical imaging system configured to determine at least a useful portion of the sugar beets suitable for sugar production and/or to determine at least a residual portion of the sugar beets not suitable for sugar production.

2. The mobile system according to claim 1, characterized in that the optical image capture system is set up to determine several useful portions of the sugar beets suitable for sugar production, in particular a portion of beet heads and/or beet bodies and/or beet tails.

3. The mobile system according to claim 1, characterized by
a beet holder for the receipt of at least a first portion of the sugar beets as a bed or beet stream,
wherein the optical image capture system has a first optical image capture device for the detection of the bed or the beet stream, which is configured to determine a portion of beet heads and/or beet bodies and/or beet tails in the bed or the beet stream as a useful portion and/or to determine a portion of foreign bodies, in particular leaves, weeds or dirt, in the bed or the beet stream as a residual portion;
optionally, characterized by a separating device for separating the certain residual portion, in particular the portion of foreign bodies, from the bed or the beet stream.

4. (canceled)

5. The mobile system according to claim 1, characterized by
a cutting device for cutting at least a second subset of the sugar beets into a cut subset comprising cut sugar beets and foreign bodies, in particular leaves, weeds or dirt, and
a near-infrared spectroscopy device for the determination of the ingredients of the cut subset, in particular the cut sugar beets,
wherein the optical image capture system has a second optical image capture device for the detection of the cut subset, which is configured to determine a portion of the cut sugar beets as the useful portion and/or a portion of the foreign bodies in the cut subset as the residual portion.

6. The mobile system according to claim 5, characterized in that;
the second optical image capture device is directed at the same area of the cut subset as the near-infrared spectroscopy device; and/or
the cutting device is set up to cut the sugar beet along an axis of the sugar beet, for example into two halves, three thirds or four quarters; and/or
the cutting device is set up to shred the sugar beets into sugar beet pulp.

7. (canceled)

8. (canceled)

9. The mobile system according to claim 5, characterized by a separating device for separating the certain residual portion, in particular the portion of foreign bodies, from the cut subset;
optionally, characterized in that the beet harvester comprises a position determination device by which the position of the beet harvester in the respective agricultural field can be determined.

10. The mobile system according to claim 1, any one of the preceding claims, characterized in that the mobile system is designed as a beet harvester and has a harvesting device for harvesting the sugar beets and a storage bunker for storing the sugar beets.

11. (canceled)

12. The mobile system according to claim 10, characterized in that; (i) the beet harvester comprises a feed device which is set up to feed sugar beets from the storage bunker to the cutting device; or
the beet harvester comprises a feed device which is set up to feed beets harvested with the harvesting device to the cutting device without the sugar beets reaching the storage bunker.

13. (canceled)

14. The mobile system according to claim 1, characterized in that the mobile system is designed as a beet cleaning loader (52) and a receiving unit for receiving sugar beets, a cleaning unit for cleaning the picked up sugar beets and an overloader for dispensing the cleaned sugar beets, in particular a separate transport vehicle;
optionally, wherein the beet cleaning loader comprises a feed device which is set up to feed cleaned beets to the cutting device;
optionally, wherein the beet cleaning loader comprises a feed device which is set up to feed sugar beets from the overloader to the cutting device.

15. (canceled)

16. (canceled)

17. The mobile system according to claim 1, characterized in that the mobile system is designed as a beet transporter (53) and has a loading area for the reception of the sugar beets;
optionally, wherein the beet transporter has a feed device which is set up to feed sugar beets from the loading area to the cutting device.

18. (canceled)

19. The mobile system according to claim 1, characterized by a communication interface, in particular for wireless communication, via which data regarding the specific useful portion and/or a specific residual portion and/or the specific ingredients can be transmitted, in particular to a sugar production plant.

20. A sugar production system with
a mobile device according to any one of the preceding claims and
with a sugar production plant,
characterized in that
the sugar production plant is set up to set at least one process parameter depending on the useful portion and/or residual portion determined with the optical image capture system;
optionally, wherein the sugar production plant is set up to additionally adjust the process parameter depending on the ingredients determined with the near-infrared spectroscopy device.

21. (canceled)

22. A method for sugar production,
wherein sugar beets are harvested and/or transported and/or loaded using a mobile,
wherein an optical image capture system of the mobile system is used to determine at least one useful portion of the sugar beet that is suitable for sugar production and/or at least one residual portion of the sugar beet that is not suitable for sugar production,
wherein, in a sugar production plant, at least one process parameter is set depending on the useful portion determined with the optical image capture system and/or the residual portion;
optionally wherein a first portion of the sugar beets is received as a bed in a beet holder of the mobile system;
optionally wherein the optical image capture system has a first optical image capture device for the detection of the bed, with which a portion of beet heads and/or beet bodies and/or beet tails in the bed is determined as the useful portion and/or with which a portion or foreign bodies, especially leaves, weeds or dirt, is determined as the residual portion;
optionally wherein depending on the determined portion of foreign bodies, in particular leaves, weeds and dirt, this portion is separated from the bed of the beet stream or this portion is removed.

23. (canceled)

24. (canceled)

25. The method according to claim 22, characterized in that
with a cutting device of the mobile system at least a second subset of the sugar beets is shredded into a cut subset comprising cut sugar beets and foreign bodies,
wherein ingredients of the cut subset, in particular the cut sugar beets, are determined using a near-infrared spectroscopy device of the mobile system and
wherein the optical image capture system has a second optical image capture device with which a portion of the cut sugar beets is determined as the useful portion and/or with which a portion of the foreign bodies in the cut subset is determined as the residual portion.

26. The method according to claim 25, characterized in that;
depending on the determined portion of foreign bodies, in particular leaves, weeds and dirt, this portion is separated from the bed of the beet stream or this portion is removed; and/or
the sugar content in the cut subset is determined using the near-infrared spectroscopy device of the mobile system.

27. (canceled)

28. The method according to claim 22, characterized in that the process parameter is a process parameter of an extraction device to which sugar beet pulp is fed and from which sugar beet pulp residues and raw juice are withdrawn.

29. The method according to claim 28, characterized in that;
the process parameter is an extraction time, which indicates the duration for which the sugar beet pulp remains in the extraction device; and/or
the process parameter is an extraction temperature which indicates the temperature at which the extraction device is operated.

30. (canceled)

31. The method according to claim 22, characterized in that the process parameter is a process parameter of a liming step.

32. The method according to claim 31, characterized in that the process parameter is an added amount of lime milk and/or a target value of the pH value and/or a concentration of the lime milk and/or an added amount of precipitated calcium carbonate and/or a withdrawn amount of mud juice concentrate.

33. The method according to claim 22, characterized in that:
the process parameter is a process parameter of a carbonization step; or
the process parameter is a process parameter of a filtration step or a thickening step or a crystallization step or a separation step.

34. (canceled)
